(19) United States
(12) Patent Application Publication
(10) Pub. No.: US 2016/0344717 A1
(43) Pub. Date: Nov. 24, 2016

(54) COMMUNICATING BETWEEN A CLUSTER AND A NODE EXTERNAL TO THE CLUSTER

(71) Applicant: HEWLETT-PACKARD DEVELOPMENT COMPANY, L.P, Houston, TX (US)

(72) Inventor: Oliver Matthews, Bristol (GB)

(21) Appl. No.: 15/114,507

(22) PCT Filed: Jan. 31, 2014
(86) PCT No.: PCT/US2014/014060

§ 371 Date: Jul. 27, 2016

(51) Int. Cl. H04L 29/06

(52) U.S. Cl. CPC H04L 63/08; H04L 63/1466

(57) ABSTRACT

A technique includes, in response to receiving an inquiry from a first node external to a cluster in a server node of a cluster, communicating server authentication data to the first node. The technique includes evaluating the first node by communicating with the first node over a temporary network set up based at least in part on the server authentication data and selectively allowing the first node to join the cluster based at least in part on the evaluation.

### BACKGROUND

Measures typically are undertaken to secure communications between nodes of a network cluster for such purposes as preventing interference with the cluster and observation of the cluster by nodes that are external to the cluster. These measures may permit some degree of communication between a candidate node that desires to join the cluster and the cluster for purposes of allowing the cluster to vet the node.

### BRIEF DESCRIPTION OF THE DRAWINGS

FIG. 1A is a schematic diagram of secured and unsecured networks illustrating an initial exchange between a cluster server node of the secured network and a node that is external to the secured network according to an example implementation.

FIG. 1B is a schematic diagram of the secured and unsecured networks of FIG. 1A in addition to another secured temporary network for allowing communication between a cluster server node and a candidate node according to an example implementation.

FIG. 1C is a schematic diagram of the secured and unsecured networks of FIG. 1A after the candidate node joins the cluster according to an example implementation.

FIG. 2 is a flow diagram depicting a technique used by a cluster server node for purposes of communicating with an external candidate node according to an example implementation.

FIG. 3 is a flow diagram depicting a technique used by an external candidate node to communicate with a cluster server node according to an example implementation.

FIG. 4 is a signal flow diagram depicting communication between the candidate node and a cluster server node according to an example implementation.

FIG. 5 is a schematic diagram of a physical machine according to an example implementation.

### DETAILED DESCRIPTION

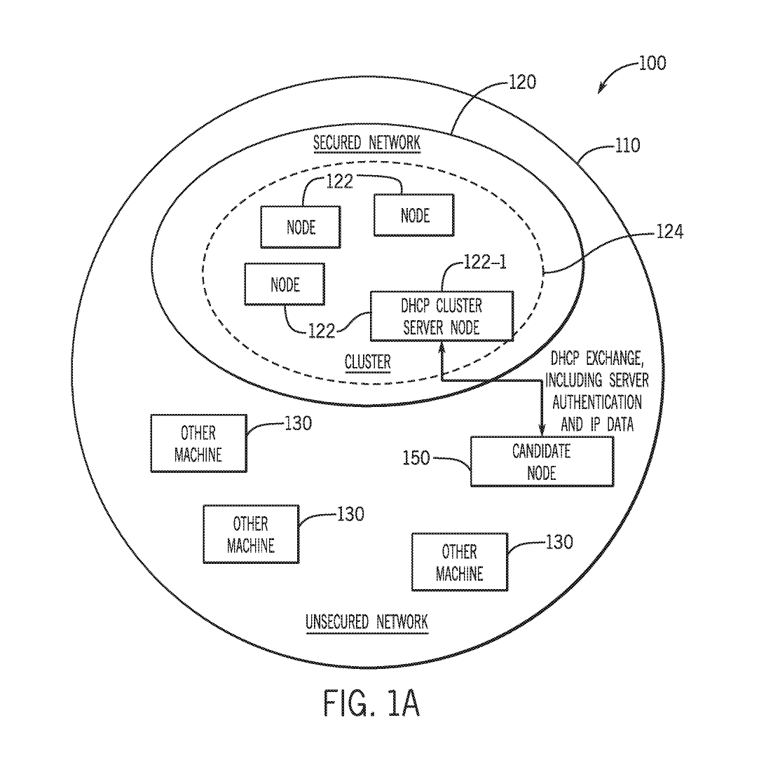

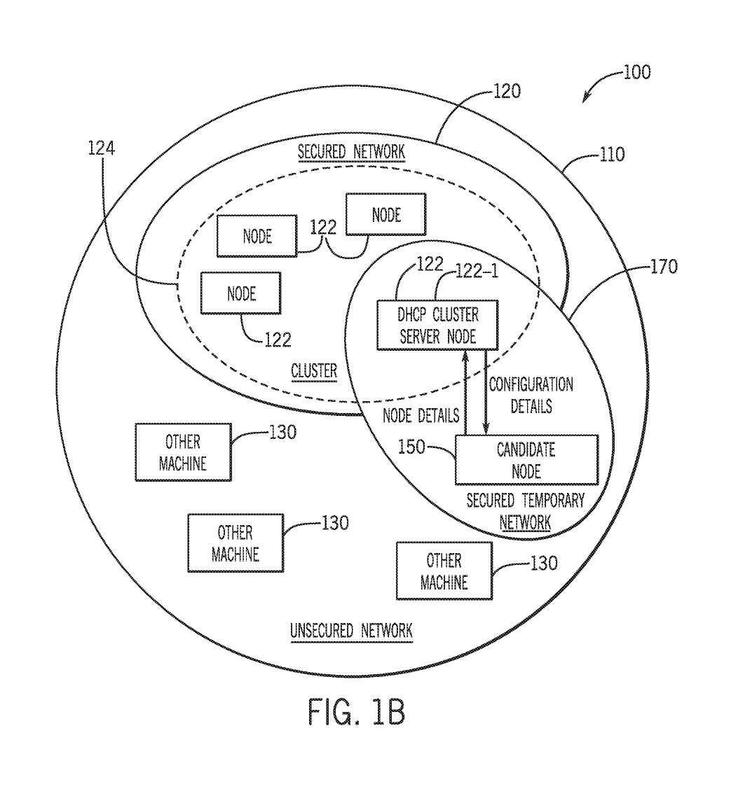

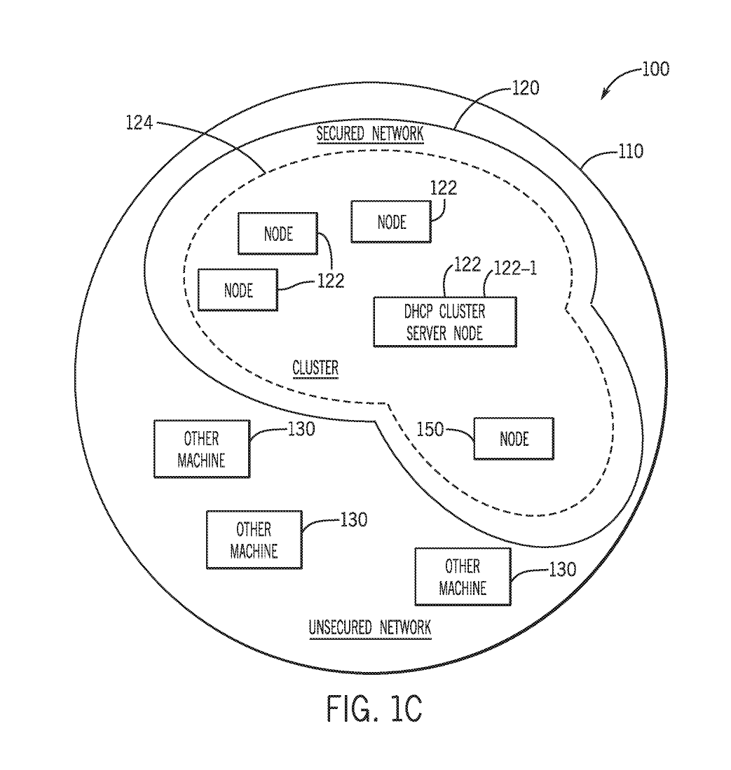

Referring to FIG. 1A, a system 100 includes an unsecured network 110, which, for this example, contains a secured network 120 that includes at least one cluster, such as example cluster 124 that contains nodes 122. In addition to the secured network 120, the unsecured network 110 contains physical machines 130, and for the following examples that are described herein, one or part of the physical machines forms a network node 150 (herein called a “candidate node”), which undertakes actions directed to investigating and potentially joining the cluster 124.

In this manner, candidate node 150 may communicate with the cluster 124 (as described herein) for such purposes as communicating information about the node 150 to the cluster 124 and acquiring information relevant to joining the cluster 124. The candidate node 150 may then join the cluster 124 if the information that is acquired by the node 150 is acceptable and if the cluster 124, after vetting the node 150, invites the node 150 to join the cluster 124. Until the candidate node 150 joins the cluster 124, the node 150 is considered to be external to the cluster 124 and external to the secured network 120.

In general, the cluster 124 is secured against interference and observation by nodes that are external to the secured network 120, such as candidate node 150, as well as nodes that may be formed from the various other physical machines 130. As such, in general, nodes outside of the secured network 120, such as candidate node 150, may not communicate or observe communications with nodes inside the secured network 120. As described herein, these security measures do permit, however, limited communications with an external candidate node, such as candidate node 150, for purposes of vetting the node 150 and potentially allowing the candidate node 150 to become part of the cluster 124 (and secured network 120).

In general, the unsecured network 110 may contain one or more clusters, such as the cluster 124 of the secured network 120. In other words, in general, the network 110 may include one or multiple clusters and may contain a mix of cluster and non-cluster machines. Each cluster hold responsibility for the allocation of Internet Protocol (IP) addresses to nodes within its secured network. For the example cluster 124, a designated cluster server node 122-1 runs as a Dynamic Host Control Protocol (DHCP) server to provide the IP addresses.

For the example of FIG. 1A, the candidate node 150 communicates with the cluster server node 122-1 to discover information about the cluster connection and to share information with the server node 122-1 about the node 150. Using the disclosed information, the cluster server node 122 vets the candidate node 150 for purposes of determining whether the candidate node 150 is allowed to join the cluster 124. More specifically, in accordance with example implementations, this communication involves a DHCP exchange in which the cluster server node 122-1 communicates server authentication data and IP data (an IP address, for example) to the candidate node 150.

In general, the server authentication data, such as a certificate (as an example), is data that is used by the candidate node 150 to configure the node 150 for authentication by the server 122-1 when the server 122-1 communicates with the node 150 over a secured temporary network 170 that is depicted in FIG. 1B. Referring to FIG. 1B, the secured temporary network 170 may further be used by the candidate node 150 to communicate data to the cluster server 122-1, such as information requested by the cluster server node 122-1 used to vet the candidate node, client authentication data, and so forth. If the candidate node 150 desires to join the cluster 124 after receiving the server authentication and IP data and the cluster server node 122-1 determines that the candidate node 150 is permitted to join the cluster 124, then the cluster server node 122-1 approves the candidate node's request and allows the node 150 to join the cluster 124 so that the node 150 becomes part of the secured network 120, as depicted in FIG. 10.

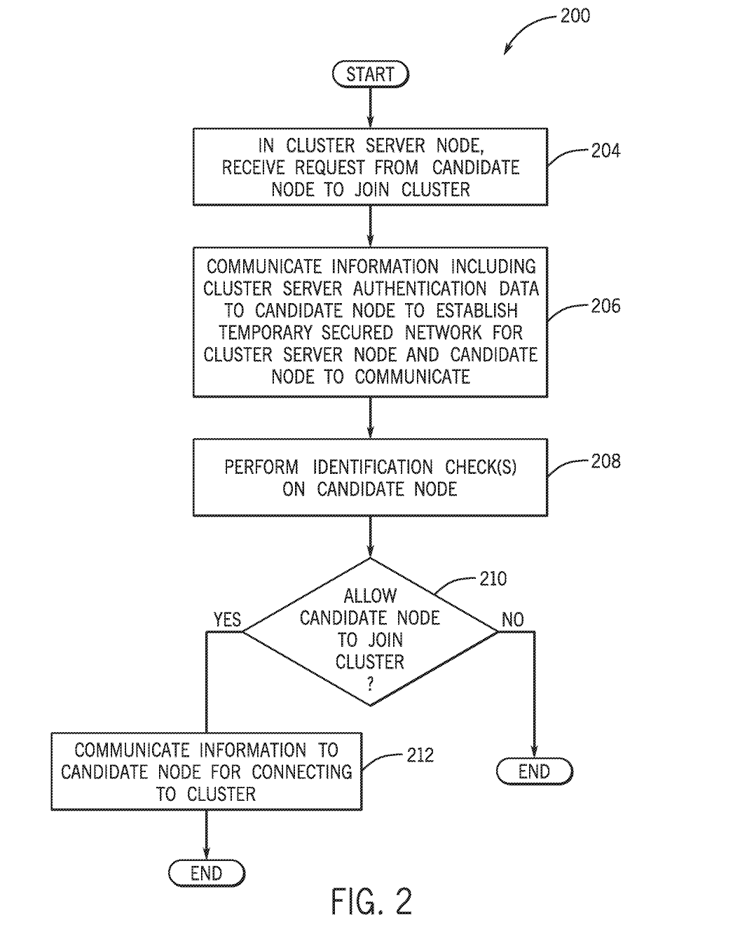

Thus, referring to FIG. 2, in accordance with example implementations, a cluster server may perform a technique 200. Pursuant to the technique, the cluster server node, receives (block 204) a request from a candidate node to join a cluster. The technique 200 includes communicating (block 206) information including cluster server authentication data (and other data, such as an IP address) from the cluster to the candidate node to establish a temporary secured network for the cluster server and the candidate node to communicate. The cluster server node may then perform (block 208) one or multiple identification checks on the candidate node and determine (decision block 210) whether the candidate node is allowed to join the cluster. If so, the cluster server node communicates information to the candidate node for connecting to the cluster, pursuant to block 212.

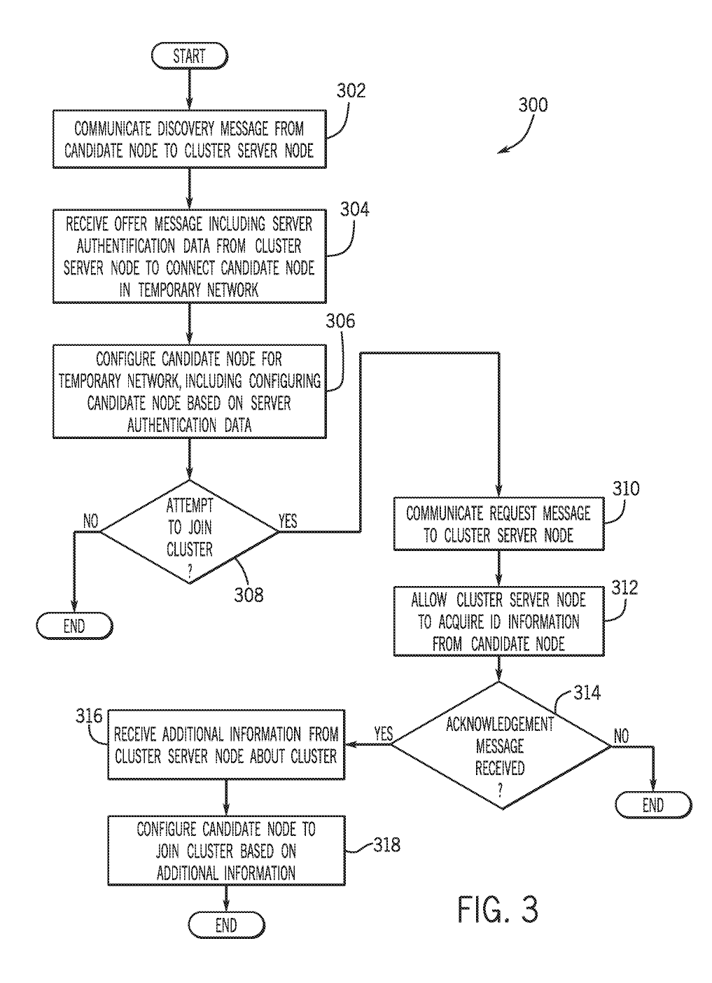

Referring to FIG. 3 in conjunction with FIG. 1, in accordance with example implementations, a candidate node may perform a technique 300 for purposes of joining a cluster. Pursuant to the technique 300, the candidate node may first communicate (block 302) a DISCOVERY message to a cluster server node of the cluster. The server node responds to the DISCOVERY message by communicating data so that the candidate node receives (block 304) information including server authentication data and other information to allow the cluster server to connect to the candidate node in a temporary network. In this manner, in accordance with example implementations, the cluster server node may respond to the DISCOVERY message with an OFFER message, which may contain, as examples, an IP address, various related network settings and additionally some form of identification data. As an example, this identification data may be a Secure Shell (SSH) public key, and in accordance with further example implementations, the identification data may be some form of certificate or other identification data.

The candidate node then configures itself for the temporary network, including configuring itself based on the server authentication data, pursuant to block 306. Assuming that the candidate node accepts the offer (as determined in decision block 308), the candidate node then communicates (block 310) a REQUEST message to the cluster server, which indicates the candidate node's desire to join the cluster. The candidate node then allows (block 312) the cluster server node to acquire identification information from the candidate node and then waits to receive an ACKNOWLEGEMENT message (decision block 314) from the server node, which indicates that the request has been accepted. For example, the candidate node may take steps to enable the cluster server node to use the supplied server authentication data to access the client by, for example, adding an SSH public key (the server authentication data for this example) to an authorized keys file, for example. In response to receiving the ACKNOWLEDGMENT message, the candidate node may receive (block 316) additional information from the cluster server node (in the ACKNOWLEGMENT message itself, for example) about the cluster. The candidate node then configures itself to join the cluster based on the additional information, pursuant to block 318. As a more specific example, the temporary network may be an SSH channel, and the cluster server node may use the channel to pass parameters to the candidate node for connecting a candidate node into the cluster, along with any other configuration actions the server node desires to take, including potentially an entirely new set of network addresses.

In accordance with further example implementations, the server node 122-1 and/or candidate node 150 may employ measures to defeat a specific type of “man-in-the-middle” attack. In this regard, the man-in-the-middle attack may be an out-of-band attack in which a machine that is not actually in a line with the network convinces (i.e., spoofs) the identities of the other machines so that (in this example) the cluster server perceives the attacker as the candidate node, and the candidate node perceives the attacker as the cluster server node. More specifically, the out-of-band man-in-the-middle attack may use either Address Resolution Protocol (ARP) poisoning/spoofing (which should be detected/stopped at the switch layer); or alternatively, the attacker may be able to successively join the network and run a second DHCP server, which offers its own authentication settings to the candidate node. Because the DHCP is a broadcast-based protocol, the real cluster server node sees the OFFER message coming from the attacker, thereby allowing the cluster server node 122-1 to raise an appropriate error. Moreover, if the candidate node receives two OFFER messages, this causes the candidate node to avoid joining the cluster, in accordance with example implementations.

If the cluster server node co-exists on the same network as other, non-cluster machines or even as other clusters, then in the initial DISCOVERY message, the candidate node may use a Vendor Class Identifier (VCI) option to indicate that the candidate node desires to join a cluster, and the candidate node may denote, or identify, the specific cluster by its choice of which offer to request or to a value set in the VCI option, depending on the specific implementation.

In accordance with example implementations, because the candidate node may communicate, via the REQUEST or DISCOVERY messages, a vendor specific field (such as the data identifying the VCI option), the candidate node may also communicate its own authentication data to the cluster server node. For example, the client authentication data may be as simple as an SSH host key or may be as complex as a full SSL certificate request, which is signed and returned in the server's ACKNOWLEDGE message. These additional checks may further harden the system against (as examples) IP/ARP spoofing after the initial DHCP messages have been exchanged. Thus, many implementations are contemplated, which are within the scope of the appended claims.

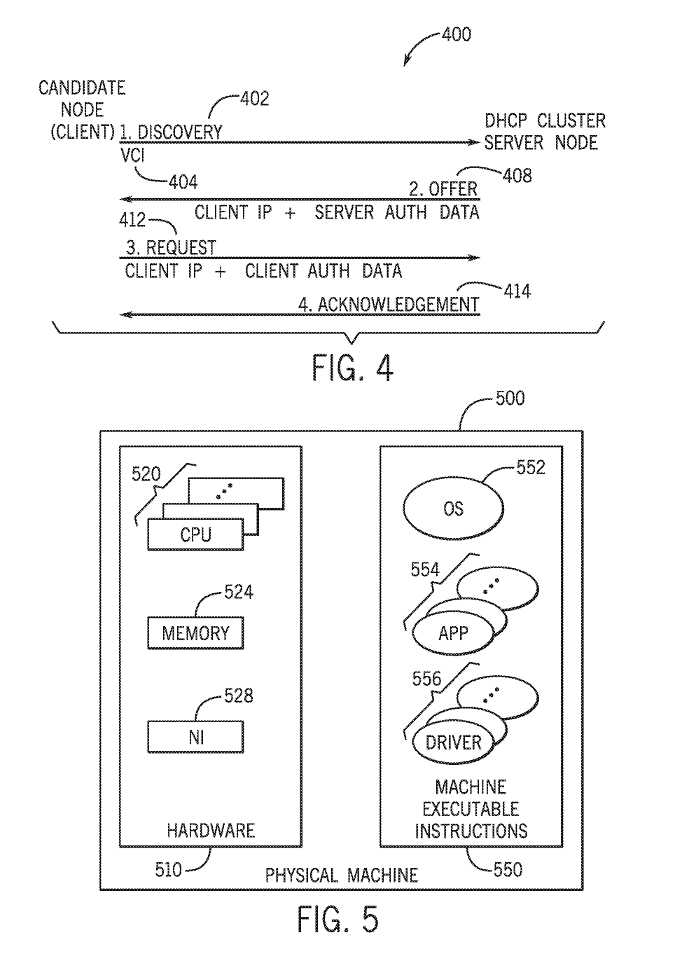

Referring to FIG. 4, as a more specific example, in accordance with example implementations, a given candidate node may communicate with a cluster server node for purposes of joining a cluster pursuant to a DCHP exchange that is represented by example signal flow 400. Referring to FIG. 4, as part of this exchange, the candidate node first communicates a DISCOVERY message 402 to the cluster server node, which may contain data that identifies a VCI option 404. The cluster server node then responds with an OFFER message 408, which contains the client IP address information, as well as the server authentication data. If the candidate node desires to join the cluster, then the candidate node communicates a REQUEST message 412, which may contain client IP information, as well as may contain client authentication data. Assuming that the cluster server node allows the candidate node to join the cluster, the server node responds with an ACKNOWLEDGMENT message 414.

In accordance with example implementations, a given node, such as the candidate node as well as the server node may, in general, be a physical machine 500, which is an actual machine that is made up of actual hardware 510 and actual machine executable instructions 550, or “software.” In this manner, the hardware 510 may include, as examples, one or multiple Central Processing Units (CPU)(s) 520 and memory 524. In general, the memory 524 is a non-transitory storage medium to store instructions that when executed by the CPU(s) 520 cause the CPU(s) 520 to perform one or more of the techniques that are disclosed herein. In general, the memory 524 may be semiconductor-based memory devices, may be a phase change memory, may be a memristor-based memory, and so forth, depending on the particular implementation. The physical machine 500 may further include hardware 510, such as, for example, a network interface 528, input devices (keyboards, pointing devices, and so forth). In general, the machine executable instructions 550 may include an operating system 552 and one or multiple drivers 556. Moreover, the machine executable instructions 550 may contain one or multiple applications 554. The driver/application, when executed by the CPU(s) 520 may cause the physical machine 550 to perform one or more of the techniques that are disclosed herein.

In accordance with further example implementations, a given node may be a virtual node, i.e., a virtual machine, which is formed by machine executable instructions that are executed on an actual physical machine. Thus, many implementations are contemplated, which are within the scope of the appended claims.

The techniques and systems that are disclosed herein may provide one or more of the following advantages. No user intervention may be needed, making it suitable for use in situations where scaling is required (e.g. cloud or factory deployments). Beyond knowledge of the protocol being used, there are no pre-shared secrets in this system, preventing vulnerabilities where they could be leaked. While the approach is authentication technology agnostic, if a public-key based system is used then candidate nodes will only expose themselves for access to the cluster and not potential attackers on the network. By allowing full access to the candidate node's system through the published authentication setup, the cluster can properly and securely vet a proposed new candidate node's suitability for inclusion in the network without having to first grant the candidate node access to the secure network. This approach does not require any additional communication channels beyond the one that will be used for communication between the nodes of the cluster, saving on expense and complexity. By associating the authentication information with the OFFER message, the authentication setup is enabled to be used to be determined based on the candidate node, if desired. For instance, this allows the cluster server node to examine multiple candidate nodes independently without the candidates being able to interact with (or even necessarily be aware of) each other. Other and different advantages are contemplated, which are within the scope of the appended claims.

While the present techniques have been described with respect to a limited number of embodiments, those skilled in the art, having the benefit of this disclosure, will appreciate numerous modifications and variations therefrom. It is intended that the appended claims cover all such modifications and variations as fall within the true spirit and scope of the present techniques.

What is claimed is:

1. A method comprising:
in response to receiving an inquiry from a first node external to a cluster in a server node of a cluster, communicating server authentication data to the first node;
evaluating the first node by communicating with the first node over a temporary network set up based at least in part on the server authentication data; and
selectively allowing the first node to join the cluster based at least in part on the evaluation.

2. The method of claim 1, wherein the cluster is a given cluster of a plurality of clusters of a network shared in common and receiving an inquiry from the first node comprises receiving an identifier identifying the given cluster.

3. The method of claim 1, further comprising:
in response to the receiving the inquiry in the server node, communicating an Internet Protocol (IP) address for the first node for use in the temporary network.

4. The method of claim 1, further comprising:
after communicating the server authentication data, waiting for a request from the first node to join the cluster; and
in response to receiving the request, communicating with the first node using the temporary network to assess the first node.

5. The method of claim 4, further comprising configuring the server node based on client authentication data supplied by the candidate node in association with the request.

6. The method of claim 1, wherein selectively allowing comprises selectively communicating an acknowledgement message to the first node indicating that the first node is allowed to join the cluster.

7. The method of claim 1, wherein communicating server data comprises communicating an offer message to the candidate node from the server node, the method further comprising:
selectively generating an attack alert in response to detecting another offer message not originating with the server node.

8. An article comprising a non-transitory computer readable storage medium to store instructions that when executed by a computer cause the computer to:
in response to receiving an inquiry from a node external to a cluster associated with the computer, cause communicate server authentication data to be communicated to the node;
communicate with the node using a temporary network set up based at least in part on the server authentication data to evaluate the node; and
selectively communicate an acknowledgment to the node indicating that the node is allowed to join the cluster based at least in part on the evaluation.

9. The article of claim 8, the storage medium storing instructions that when executed by the computer cause the computer to:
cause the server authentication data to be communicated to the node in an offer message, the offer message further indicating an Internet Protocol (IP) address for the node for the temporary network.

10. The article of claim 8, the storage medium storing instructions that when executed by the computer cause the computer to:
in response to receiving the request, communicate with the first node using the temporary network to assess the first node

11. The article of claim 8, the storage medium storing instructions that when executed by the computer cause the computer to:
in response to receiving a request from the node to join the cluster, selectively communicate an acknowledgement message to the node indicating that the first node is allowed to join the cluster based at least in part on the evaluation.

12. A system comprising:
a cluster comprising a server node; and
a candidate node external to the cluster, the candidate node to, in response to communicating an inquiry to the cluster, receive authentication data from the cluster; and
a candidate node to:
in response to communicating an inquiry to the cluster, receive authentication data from the cluster; and
selectively configure the candidate node to be in a temporary network to allow the cluster to evaluate the candidate node.

13. The system of claim 12, wherein the candidate node communicates a request to the cluster to indicate that the candidate node desires to join the cluster.

14. The system of claim 13, wherein the candidate node communicates authentication data for the candidate node in associated with the request.

15. The system of claim 12, wherein the server node causes the server authentication data to be communicated to the node in an offer message, and the node selectively generates an error alert in response to detecting another offer message appearing to be associated with the server node.
